(19) United States
(12) Patent Application Publication
(10) Pub. No.: US 2023/0169175 A1
(43) Pub. Date: Jun. 1, 2023

(54) Managing Zero-Day Vulnerabilities

(71) Applicant: International Business Machines Corporation, Armonk, NY (US)

(72) Inventors: Vijay Kumar Ananthapur Bache, Santa Rosa Beach, FL (US); Arvind Rangarajan, Chennai (IN); Srithar Rajan Thangaraj, Chennai (IN); Pradeep Raj Jayarathanasamy, Chennai (IN); Bidhu Ranjan Sahoo, Bengaluru (IN)

(21) Appl. No.: 17/456,837

(22) Filed: Nov. 29, 2021

(51) Int. Cl. G06F 21/57; G06F 8/75; G06N 5/04

(52) U.S. Cl. CPC G06F 21/577; G06F 8/75; G06N 5/04; G06F 2221/033

(57) ABSTRACT

A computer implemented method manages zero-day vulnerabilities in an application package having a set of components. The computer ingests data about potential vulnerabilities from a plurality of data sources. Using a set of machine learning models, the computer predicts a vulnerability based on of the data that was ingested. The computer performs a code analysis of the set of components to identify a possibility of the vulnerability impacting the application package. The computer generates a recommendation to resolve the vulnerability based on the code analysis and the data that was ingested. The computer manages the recommendation in a private blockchain.

### BACKGROUND

### 1. Field

The disclosure relates generally to an improved computer system and more specifically to a method, apparatus, computer system, and computer program product for managing zero-day vulnerabilities in an application package.

### 2. Description of the Related Art

“Vulnerabilities” are flaws in a system that can leave it open to attack. A vulnerability may refer to any type of weakness in a computer system itself, a software package, a set of procedures, or anything that leaves information security exposed to a threat. A vulnerability may allow an attacker to execute commands as another user, to access data that is contrary to the specified access restrictions, or to conduct a denial-of-service attack.

“Zero-day vulnerabilities” represent one of the most critical security threats. A zero-day vulnerability is a computer-software vulnerability that is either: (a) known but unresolved, such as through a patch or other mitigation; or (2) unknown to various stakeholders in the mitigation process, including software developers, vendors. Until the vulnerability is mitigated, hackers can exploit it to adversely affect programs, data, additional computers, or a network.

Identifying a zero-day vulnerability is an extraordinarily complex task, and preforming preventive and corrective actions is critical to the security of the enterprise systems. Timely detection of security breach exploits based upon new unpatched software vulnerabilities is critical. A single security breach likely exposes the software to follow-up attacks from malicious actors seeking to further exploit the vulnerability.

### SUMMARY

According to one illustrative embodiment, a computer implemented method for managing zero-day vulnerabilities in an application package having a set of components is provided. The computer system ingests data about potential vulnerabilities from a plurality of data sources. Using a machine learning model, the computer system predicts a vulnerability based on the data that was ingested. The computer system performs a code analysis of the set of components to identify a possibility of the vulnerability impacting the application package. The computer system generates a recommendation to resolve the vulnerability based on the code analysis and the data that was ingested. The computer system manages the recommendation in a private blockchain.

According to other illustrative embodiments, a computer system and computer program product for managing zero-day vulnerabilities in an application package having a set of components are provided.

### BRIEF DESCRIPTION OF THE DRAWINGS

FIG. 1 is a diagram illustrating a cloud computing environment in which illustrative embodiments may be implemented;

FIG. 2 is a diagram illustrating abstraction model layers in accordance with one or more illustrative embodiments;

FIG. 3 is a diagram of a data processing system depicted in accordance with one or more illustrative embodiments;

FIG. 4 is a block diagram of a vulnerability management environment in accordance with one or more illustrative embodiments;

FIG. 5 is a flowchart of a process for managing zero-day vulnerabilities in an application package depicted in accordance with one or more illustrative embodiments;

FIG. 6 is a flowchart of a first process for ingesting data about potential vulnerabilities depicted in accordance with one or more illustrative embodiments;

FIG. 7 is a flowchart of a second process for ingesting data about potential vulnerabilities depicted in accordance with one or more illustrative embodiments;

FIG. 8 is a flowchart of a first process for determining a resolution to the vulnerability depicted in accordance with one or more illustrative embodiments;

FIG. 9 is a flowchart of a second process for determining a resolution to the vulnerability depicted in accordance with one or more illustrative embodiments;

FIG. 10 is a flowchart of a process for managing the recommendation in a private blockchain depicted in accordance with one or more illustrative embodiments; and

FIG. 11 is a flowchart of a process for dispatching a solution depicted in accordance with one or more illustrative embodiments.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account various considerations. For example, the illustrative embodiments recognize and take into account that there is no single solution to automatically identify potential vulnerabilities and corelate those vulnerabilities to the various data that that can elucidate the underlying issues.

In accordance with one or more illustrative embodiments, intelligent zero-day vulnerability prediction, analysis and mitigation is provided. The illustrative embodiments ingest data from multiple data sources, including security data from social media platforms. Illustrative embodiments use machine learning to understand and model outbreaks of vulnerability exploits. The possibility of the zero-day vulnerability in a given system can be cognitively identified through static and dynamic security verification and validations. As mitigating resolutions of the identified potential issues are created, these resolutions tracked to deployment within a private blockchain, providing transparency and consensus-based accountability to the proposed resolutions.

The illustrative embodiments provide intelligent solutions to zero-day vulnerability using blockchain, enabling an early warning to the product vendors and also the product consumers. The illustrative embodiments enable the identification of zero-day vulnerabilities and unknown threats in the software without requiring any security fuzzing or testing. Additionally, the illustrative embodiments can be integrated with Security Information and Event Management (SIEM) solutions and threat intelligence services to provide a product ecosystem for predicting, characterizing, and managing zero-day vulnerabilities.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

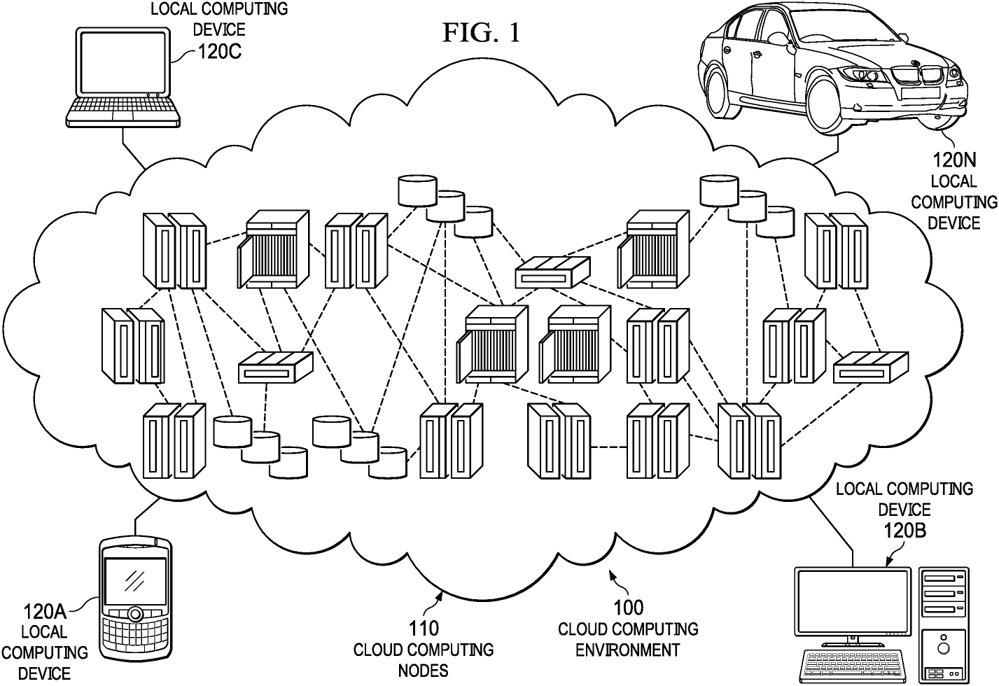

With reference now to FIG. 1, a diagram illustrating a cloud computing environment is depicted in which illustrative embodiments may be implemented. In this illustrative example, cloud computing environment 100 includes a set of one or more cloud computing nodes 110 with which local computing devices used by cloud consumers, such as, for example, personal digital assistant or smart phone 120A, desktop computer 120B, laptop computer 120C, and/or automobile computer system 120N, may communicate.

Cloud computing nodes 110 may communicate with one another and may be grouped physically or virtually into one or more networks, such as private, community, public, or hybrid clouds as described hereinabove, or a combination thereof. This allows cloud computing environment 100 to offer infrastructure, platforms, and/or software as services for which a cloud consumer does not need to maintain resources on a local computing device, such as local computing devices 120A-120N. It is understood that the types of local computing devices 120A-120N are intended to be illustrative only and that cloud computing nodes 110 and cloud computing environment 100 can communicate with any type of computerized device over any type of network and/or network addressable connection using a web browser, for example.

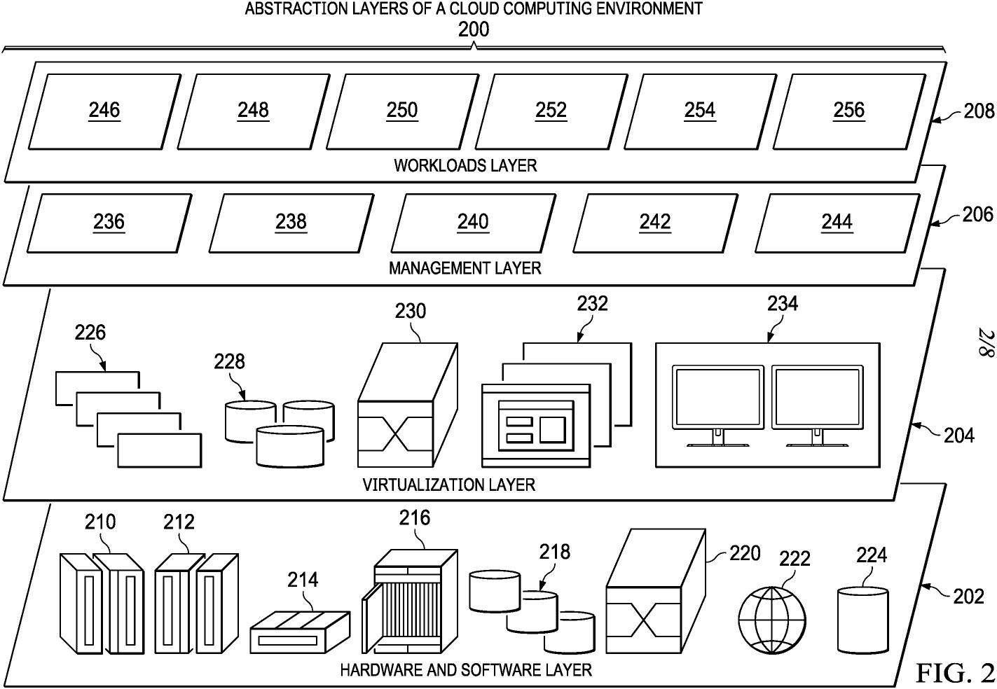

With reference now to FIG. 2, a diagram illustrating abstraction model layers is depicted in accordance with one or more illustrative embodiments. The set of functional abstraction layers shown in this illustrative example may be provided by a cloud computing environment, such as cloud computing environment 100 in FIG. 1. It should be understood in advance that the components, layers, and functions shown in FIG. 2 are intended to be illustrative only and embodiments of the invention are not limited thereto. As depicted, the following layers and corresponding functions are provided.

Abstraction layers of a cloud computing environment 200 include hardware and software layer 202, virtualization layer 204, management layer 206, and workloads layer 208. Hardware and software layer 202 includes the hardware and software components of the cloud computing environment. The hardware components may include, for example, mainframes 210, RISC (Reduced Instruction Set Computer) architecture-based servers 212, servers 214, blade servers 216, storage devices 218, and networks and networking components 220. In some illustrative embodiments, software components may include, for example, network application server software 222 and database software 224.

Virtualization layer 204 provides an abstraction layer from which the following examples of virtual entities may be provided: virtual servers 226; virtual storage 228; virtual networks 230, including virtual private networks; virtual applications and operating systems 232; and virtual clients 234.

In one example, management layer 206 may provide the functions described below. Resource provisioning 236 provides dynamic procurement of computing resources and other resources, which are utilized to perform tasks within the cloud computing environment. Metering and pricing 238 provide cost tracking as resources that are utilized within the cloud computing environment, and billing or invoicing for consumption of these resources. In one example, these resources may comprise application software licenses. Security provides identity verification for cloud consumers and tasks, as well as protection for data and other resources. User portal 240 provides access to the cloud computing environment for consumers and system administrators. Service level management 242 provides cloud computing resource allocation and management such that required service levels are met. Service level agreement (SLA) planning and fulfillment 244 provides pre-arrangement for, and procurement of, cloud computing resources for which a future requirement is anticipated in accordance with an SLA.

Workloads layer 208 provides examples of functionality for which the cloud computing environment may be utilized. Example workloads and functions, which may be provided by workload layer 208, may include mapping and navigation 246, software development and lifecycle management 248, virtual classroom education delivery 250, data analytics processing 252, transaction processing 254, and vulnerability manager 256.

In this example, vulnerability manager 256 can operate to predict, identify, and mitigate zero-day vulnerabilities. In one or more illustrative examples, vulnerability manager 256 manages zero-day vulnerabilities for an application package in a manner that provides transparency and consensus-based accountability to proposed resolutions of predicted zero-day vulnerabilities.

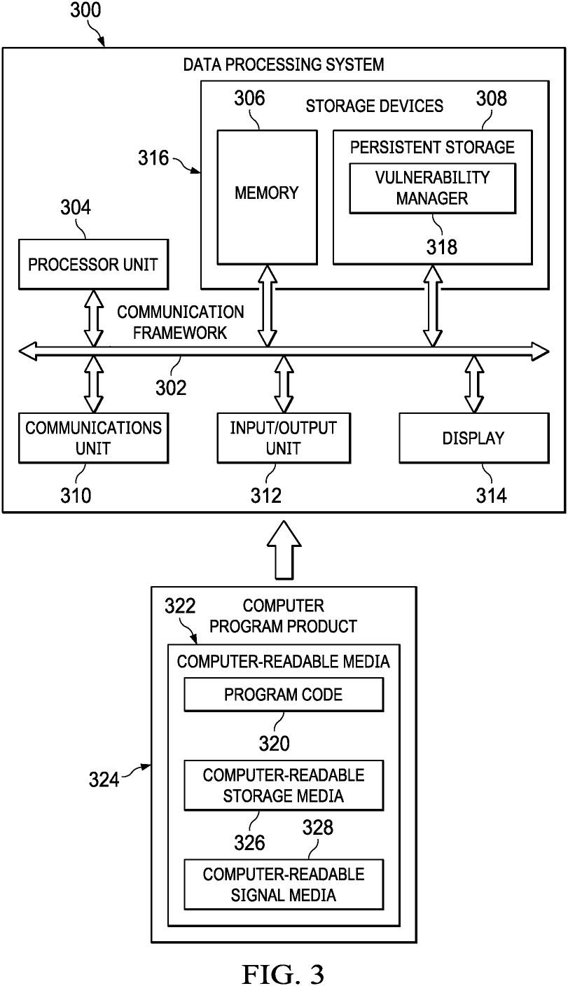

With reference now to FIG. 3, a diagram of a data processing system is depicted in accordance with one or more illustrative embodiments. Data processing system 300 is an example of a computer, such as controller node 104 in FIG. 1, in which computer-readable program code or instructions implementing the workload manager processes of illustrative embodiments may be located. In this example, data processing system 300 includes communications fabric 302, which provides communications between processor unit 304, memory 306, persistent storage 308, communications unit 310, input/output (I/O) unit 312, and display 314.

Processor unit 304 serves to execute instructions for software applications and programs that may be loaded into memory 306. Processor unit 304 may be a set of one or more hardware processor devices or may be a multi-core processor, depending on the particular implementation.

Memory 306 and persistent storage 308 are examples of storage devices 316. As used herein, a computer-readable storage device or a computer-readable storage medium is any piece of hardware that is capable of storing information, such as, for example, without limitation, data, computer-readable program instructions in functional form, and/or other suitable information either on a transient basis or a persistent basis. Further, a computer-readable storage device or a computer-readable storage medium excludes a propagation medium, such as transitory signals. Furthermore, a computer-readable storage device or a computer-readable storage medium may represent a set of computer-readable storage devices or a set of computer-readable storage media. Memory 306, in these examples, may be, for example, a random-access memory (RAM), or any other suitable volatile or non-volatile storage device, such as a flash memory. Persistent storage 308 may take various forms, depending on the particular implementation. For example, persistent storage 308 may contain one or more devices. For example, persistent storage 308 may be a disk drive, a solid-state drive, a rewritable optical disk, a rewritable magnetic tape, or some combination of the above. The media used by persistent storage 308 may be removable. For example, a removable hard drive may be used for persistent storage 308.

In this example, persistent storage 308 stores vulnerability manager 318. However, it should be noted that even though vulnerability manager 318 is illustrated as residing in persistent storage 308, in an alternative illustrative embodiment, vulnerability manager 318 may be a separate component of data processing system 300. For example, vulnerability manager 318 may be a hardware component coupled to communication fabric 302 or a combination of hardware and software components.

Vulnerability manager 318 provides methods for managing zero-day vulnerabilities in an application package having a set of components. Vulnerability manager 318 ingests data about potential vulnerabilities from a plurality of data sources. Using a set of machine learning models, vulnerability manager 318 predicts a vulnerability based on of the data that was ingested. Vulnerability manager 318 performs a code analysis of the set of components to identify a possibility of the vulnerability impacting the application package. Vulnerability manager 318 generates a recommendation to resolve the vulnerability based on both the code analysis and the data that was ingested. Vulnerability manager 318 manages the recommendation in a private blockchain.

Communications unit 310, in this example, provides for communication with other computers, data processing systems, and devices via a network, such as network 102 in FIG. 1. Communications unit 310 may provide communications through the use of both physical and wireless communications links. The physical communications link may utilize, for example, a wire, cable, universal serial bus, or any other physical technology to establish a physical communications link for data processing system 300. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 300.

Input/output unit 312 allows for the input and output of data with other devices that may be connected to data processing system 300. For example, input/output unit 312 may provide a connection for user input through a keypad, a keyboard, a mouse, a microphone, and/or some other suitable input device. Display 314 provides a mechanism to display information to a user and may include touch screen capabilities to allow the user to make on-screen selections through user interfaces or input data, for example.

Instructions for the operating system, applications, and/or programs may be located in storage devices 316, which are in communication with processor unit 304 through communications fabric 302. In this illustrative example, the instructions are in a functional form on persistent storage 308. These instructions may be loaded into memory 306 for running by processor unit 304. The processes of the different embodiments may be performed by processor unit 304 using computer-implemented instructions, which may be located in a memory, such as memory 306. These program instructions are referred to as program code, computer usable program code, or computer-readable program code that may be read and run by a processor in processor unit 304. The program instructions, in the different embodiments, may be embodied on different physical computer-readable storage devices, such as memory 306 or persistent storage 308.

Program instructions 320 is located in a functional form on computer-readable media 322 that is selectively removable and may be loaded onto or transferred to data processing system 300 for running by processor unit 304. Program instructions 320 and computer-readable media 322 form computer program product 324. In one example, computer-readable media 322 may be computer-readable storage media 326 or computer-readable signal media 328.

In these illustrative examples, computer-readable storage media 326 is a physical or tangible storage device used to store program instructions 320 rather than a medium that propagates or transmits program instructions 320. Computer-readable storage media 326 may include, for example, an optical or magnetic disc that is inserted or placed into a drive or other device that is part of persistent storage 308 for transfer onto a storage device, such as a hard drive, which is part of persistent storage 308. Computer-readable storage media 326 also may take the form of a persistent storage, such as a hard drive, a thumb drive, or a flash memory that is connected to data processing system 300.

Alternatively, program instructions 320 may be transferred to data processing system 300 using computer-readable signal media 328. Computer-readable signal media 328 may be, for example, a propagated data signal containing program instructions 320. For example, computer-readable signal media 328 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer-readable media” can be singular or plural. For example, program instructions 320 can be located in computer-readable media 322 in the form of a single storage device or system. In another example, program instructions 320 can be located in computer-readable media 322 that is distributed in multiple data processing systems. In other words, some instructions in program instructions 320 can be located in one data processing system while other instructions in program instructions 320 can be located in one or more other data processing systems. For example, a portion of program instructions 320 can be located in computer-readable media 322 in a server computer while another portion of program instructions 320 can be located in computer-readable media 322 located in a set of client computers.

The different components illustrated for data processing system 300 are not meant to provide architectural limitations to the manner in which different embodiments can be implemented. In some illustrative examples, one or more of the components may be incorporated in or otherwise form a portion of, another component. For example, memory 306, or portions thereof, may be incorporated in processor unit 304 in some illustrative examples. The different illustrative embodiments can be implemented in a data processing system including components in addition to or in place of those illustrated for data processing system 300. Other components shown in FIG. 3 can be varied from the illustrative examples shown. The different embodiments can be implemented using any hardware device or system capable of running program instructions 320.

The different components illustrated for data processing system 300 are not meant to provide architectural limitations to the manner in which different embodiments may be implemented. The different illustrative embodiments may be implemented in a data processing system including components in addition to, or in place of, those illustrated for data processing system 300. Other components shown in FIG. 2 can be varied from the illustrative examples shown. The different embodiments may be implemented using any hardware device or system capable of executing program instructions. As one example, data processing system 300 may include organic components integrated with inorganic components and/or may be comprised entirely of organic components excluding a human being. For example, a storage device may be comprised of an organic semiconductor.

As another example, a computer readable storage device in data processing system 300 is any hardware apparatus that may store data. Memory 306, persistent storage 308, and computer-readable storage media 326 are examples of physical storage devices in a tangible form.

In another example, a bus system may be used to implement communications fabric 302 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 306 or a cache such as found in an interface and memory controller hub that may be present in communications fabric 302.

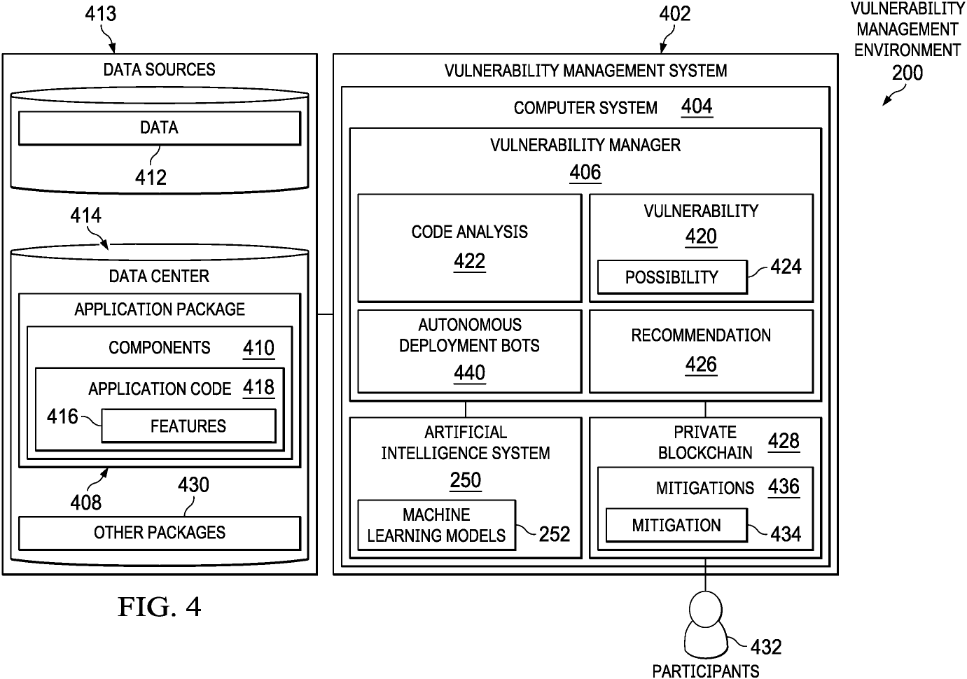

With reference now to FIG. 4, a block diagram of a vulnerability management environment is depicted in accordance with one or more illustrative embodiments. In this illustrative example, vulnerability management environment 400 includes components that can be implemented in hardware such as the hardware shown in cloud computing environment 100 in FIG. 1 and data processing system 300 in FIG. 3.

As depicted, vulnerability management system 402 comprises computer system 404 and vulnerability manager 406. Vulnerability manager 406 runs in computer system 404. Vulnerability manager 406 provides methods for managing zero-day vulnerabilities in an application package 408 having a set of components 410.

Vulnerability manager 406 can be implemented in software, hardware, firmware, or a combination thereof. When software is used, the operations performed by vulnerability manager 406 can be implemented in program instructions configured to run on hardware, such as a processor unit. When firmware is used, the operations performed by vulnerability manager 406 can be implemented in program instructions and data and stored in persistent memory to run on a processor unit. When hardware is employed, the hardware may include circuits that operate to perform the operations in vulnerability manager 406.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 404 is a physical hardware system and includes one or more data processing systems. When more than one data processing system is present in computer system 404, those data processing systems are in communication with each other using a communications medium. The communications medium can be a network. The data processing systems can be selected from at least one of a computer, a server computer, a tablet computer, or some other suitable data processing system.

In this illustrative example, vulnerability manager 406 ingesting data 412 about potential vulnerabilities from a plurality of data sources 413. Data 412 about the potential vulnerabilities can include, for example but not limited to, crowd-sourced information (e.g., social-sourced information), vulnerability information, product information, and data center information.

As used herein, “vulnerability information” can include various vulnerability lists, databases, descriptions, social networking platforms, web blogs, and news sites, as well as other suitable data sources that can be used for tracking or distributing vulnerability information. For example, the National Vulnerability Database (NVD), the Common Vulnerabilities and Exposures (CVE), and the Open Web Application Security Project (OWASP) can be used.

As used herein, “social-sourced information” can include certain social networks, blogs, discussion groups, and online communities that share information about computer security breaches. These social forums can include both ethical (i.e., “white hat”) and known unethical (i.e., “black hat”) hacking communities.

Product information can be recorded in one or more configuration Management Databases (CMDB), which help to track various software products and versions available in the market. Product information can include all relevant information about hardware and software components, as well as the relationships between those components.

Data center information can include Information about running products and product history, such as versions and patching information. Data center information may also include deny-list repositories maintained by a data center, such as data center 414. Deny-list repositories can list known addresses of malicious communications, such as viruses and malware.

In one illustrative example, data 412 about potential vulnerabilities includes features 416 identified from the application code 418. Vulnerability manager 406 receives application code 418 for the set of components 410 and identifies features 416 of the application code 418 based on the code analysis of the components 410.

Code analysis can include a static analysis that analyzes and evaluates application code 418 without actually running application package 408 or components 410. Code analysis can include a dynamic analysis that analyzes and evaluates application package 408 or components 410 during runtime. Features 416 can include, for example, a programming language, libraries, and subroutines, as well as other programming constructs.

In one illustrative example, Vulnerability manager 406 scans data 412, including cyber security related articles, cyber security related discussions, and security governance blogs, for mentions of the features 416 that were identified by the code analysis. In an illustrative example, vulnerability manager 406 scans vulnerability information, including data center information for running products, product history, and a deny-list repository information and product information. Vulnerability manager 406 may then map product version information to Internet protocol (IP) addresses in the deny-list repository information. Vulnerability manager 406 may match release notes of the product information with data 412, such as vulnerability information in a vulnerability database.

In some examples, vulnerability manager 406 can use artificial intelligence system 450. Artificial intelligence system 450 is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In this illustrative example, artificial intelligence system 450 can include a set of machine learning models 452. A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, an unsupervised learning, a feature learning, a sparse dictionary learning, and anomaly detection, association rules, or other types of learning algorithms. Examples of machine learning models include an artificial neural network, a decision tree, a support vector machine, a Bayesian network, a genetic algorithm, and other types of models. These machine learning models can be trained using a training data set and process additional data to provide a desired output. In this illustrative example, vulnerability manager 406 uses machine learning models 452 to predict a vulnerability 420 based on the data 412 that was ingested.

In one illustrative example, one or more machine learning models 452 may employ a regression analysis of data center information. For example, in an example scenario, a patch is released and applied to an operating system in a first data center. Two days later, the first data center identifies unusual network traffic, without conclusion on vulnerability. A second data center, which applied the patch one day before the first data center, now reports new deny-listed IP addresses. In this scenario, a regression analysis may predict a high probability of a zero-day vulnerability, which can be further confirmed from discussions on social-sourced information.

Based on features 416 identified when performing a code analysis 422 of the components 410, Vulnerability manager 406 can identify a possibility 424 of the vulnerability 420 impacting the application package 408. For example, one or more machine learning models 452 may employ a similarity analysis of data center information. For example, when application release notes match known vulnerabilities in a vulnerability database, machine learning models 452 may be used to identify similar product histories, as well as similar past issues of those similar product, thereby providing a shortlist of potential issues in vulnerability 420.

In one illustrative example, vulnerability manager 406 generates a recommendation to resolve the vulnerability based on the code analysis and the data that was ingested. Vulnerability manager 406 identifies mitigations 436 to other packages 430 recorded in the private blockchain 428. Vulnerability manager 406 identifies a probable issue based on the code analysis 422 and mitigations 436 applied to the other packages 430. Vulnerability manager 406 can then generate a recommendation 426 to address the probable issue.

For example, based on code analysis 422 and similarities identified by machine learning models 452, vulnerability manager 406 can provide a recommendation 426 based on identification of actual issue from the shortlist of vulnerabilities, as well as any mitigations 436 previously applied to other packages 430.

In these illustrative examples, vulnerability manager 406 manages the recommendation 426 in a private blockchain 428. Private blockchain 428 provides an immutable record of recommendations and any consensus-approved mitigations for components 410 of application package 408, as well as other packages 430. In this regard, private blockchain 428 a transparent record of transactions, which can be cross-referenced in a variety of manners, whether for purposes of auditing, verifying, or simply referencing blockchain transactions. For example, vulnerability manager 406 may identify mitigations 436 to other packages 430 recorded in the private blockchain 428 as part of generating a recommendation 426 to resolve the vulnerability 420.

As used herein, a “blockchain” is a data structure comprised of a series of “blocks,” sequentially linked via the pointers within the block headers. Each block may comprise data (including “data records” or “transactions”), and metadata. A block’s metadata may include a timestamp, a hash value of data records within the block, and a pointer (e.g., a hash value) to the previous block in the blockchain. Modification of a block alters the hash values found in block headers, enabling the system to identify when data has been modified.

A “blockchain ledger” is a distributed ledger which uses blockchain data structures. Because a blockchain may not be modified without altering hash values in block headers, A blockchain ledger provides an immutable record of transactions that can relied upon by the disparate nodes of the blockchain.

As used herein, a “private blockchain,” refers to a blockchain that use an access control layer to govern who has access to the network, such that only authorized users may take certain actions with respect to the blockchain ledger. For example, only authorized users or devices of a certain entity or other organization may be permitted to add new data records, or to participate in the blockchain’s consensus mechanism. Private blockchains do not rely on anonymous nodes to validate transactions. Instead, participants in the private blockchain networks must undergo a vetting process. Private blockchains may also sometimes be referred to as “permissioned blockchains,” “hybrid blockchains,” or “consortium blockchains.”

In one illustrative embodiment, vulnerability manager 406 submits the recommendation 426 to private blockchain 428 for consumption by participants 432 in private blockchain 428. In these illustrative examples, participants 432 can be the various stakeholders in a threat management process. For example, participants 432 may include, for example but not limited to, product vendors, product consumers, product owners, hardware and software enterprises, leading threat classification blogs and services, and vetted members of the “white hat” ethical hacking community, as well as other stakeholders in a threat management process.

Participants 432 consume recommendation 426 from private blockchain 428. Participants 432 may independently generate mitigation 434, such as a patch or solution, to address vulnerability 420. Participants 432 may then submit mitigation 434 back into the blockchain ledger of private blockchain 428 for consumption and consensus by other ones of participants 432.

Participants 432 may work independently to generate mitigations 436. Therefore, one or more different mitigations 436 may be submitted from different participants among participants 432, resulting in a set of mitigations 436 being submitted to the private blockchain 428. Private blockchain 428 may employ a consensus mechanism to identify a mitigation 434 that is consensus- approved from among the set of mitigations 436.

As used herein, “consensus,” “consensus algorithm,” or “consensus mechanism” as refers to the process or processes by which nodes come to an agreement with respect to the contents of the distributed ledger. Changes to the ledger may require consensus to be reached by the nodes in order to become a part of the authentic version of the ledger. In this way, the consensus mechanism may ensure that each node maintains a copy of the distributed ledger that is consistent with the copies of the distributed ledger hosted on the other nodes. Known consensus mechanisms include proof-of-work (“PoW”), proof-of-stake (“PoS”), or practical byzantine fault tolerance (“PBFT”).

In one illustrative embodiment, vulnerability manager 406 uses smart contracts as part of an active participation consensus mechanism among participants 432. For example, each of mitigation 434 submitted to the blockchain may be separately recorded with a corresponding smart contract, thereby creating one or more temporary forks in private blockchain 428. The smart contract may specify a threshold level of assent among participants 432. Participants 432 are able to examine the different ones of mitigations 436 and provide approval of a mitigation, which can be tracked by a corresponding smart contract. When the threshold conditions specified in a smart contract are satisfied, the consensus-approved mitigation is added to the main chain of the blockchain ledger, with the remaining mitigations becoming orphaned blocks.

In one illustrative example, vulnerability manager 406 can automatically dispatch a mitigation that is consensus-approved for deployment to the application package in response to a consensus among participants 432. For example, vulnerability manager 406 may use one or more autonomous deployment bots 440 to consume blockchain data and look for the consensus-approved mitigations. Vulnerability manager 406 may use one or more autonomous deployment bots 440 to translate mitigations for automatic dispatch and deployment according to an enhanced Security Content Automation Protocol (SCAP).

In one illustrative example, Autonomous deployment bots 440 may use an enhanced implementation of a Security Content Automation Protocol, such as OpenSCAP, to translate and package the mitigation for dispatch and deployment to a data center. Security Content Automation Protocol is a method for using specific standards to enable automated vulnerability management, measurement, and policy compliance evaluation of systems deployed in an organization.

Thus, illustrative embodiments provide a vulnerability management system for managing zero-day vulnerabilities in an application package having a set of components. The computer ingests data about potential vulnerabilities from a plurality of data sources. Using a set of machine learning models, the computer predicts a vulnerability based on the data that was ingested. The computer performs a code analysis of the set of components to identify a possibility of the vulnerability impacting the application package. The computer generates a recommendation to resolve the vulnerability based on the code analysis and the data that was ingested. The computer manages the recommendation in a private blockchain.

Consequently, illustrative embodiments provide one or more technical solutions that overcome a technical problem with managing zero-day vulnerabilities in an application package. As a result, these one or more technical solutions provide a technical effect and practical application in the field of assessing vulnerabilities and evaluating computer system security.

The illustration of vulnerability management environment 400 in FIG. 4 is not meant to imply physical or architectural limitations to the manner in which one or more illustrative embodiments can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in one or more illustrative embodiments.

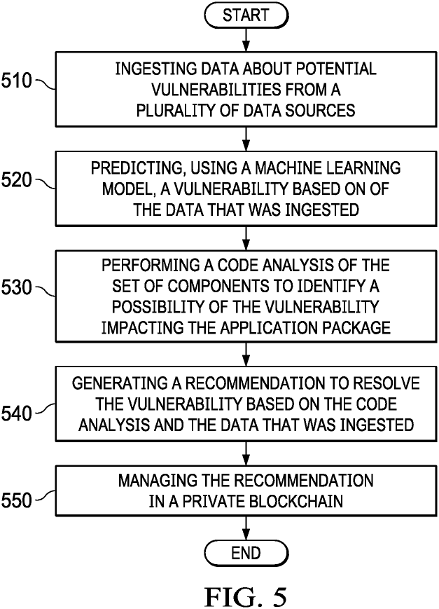

Turning now to FIG. 5, a flowchart of a process for managing zero-day vulnerabilities in an application package is depicted in accordance with one or more illustrative embodiments. The process in FIG. 5 can be implemented in hardware, software, or both. When implemented in software, the process can take the form of program instructions that is run by one of more processor units located in one or more hardware devices in one or more computer systems. For example, the process can be implemented in vulnerability manager 406 in FIG. 4.

The process begins by ingesting data about potential vulnerabilities from a plurality of data sources (step 510). Using a set of machine learning models, the process predicts a vulnerability based on of the data that was ingested (step 520). The process performs a code analysis of the set of components to identify a possibility of the vulnerability impacting the application package (step 530). The process generates a recommendation to resolve the vulnerability based on the code analysis and the data that was ingested (step 540). The process manages the recommendation in a private blockchain (step 550). Thereafter, the process terminates.

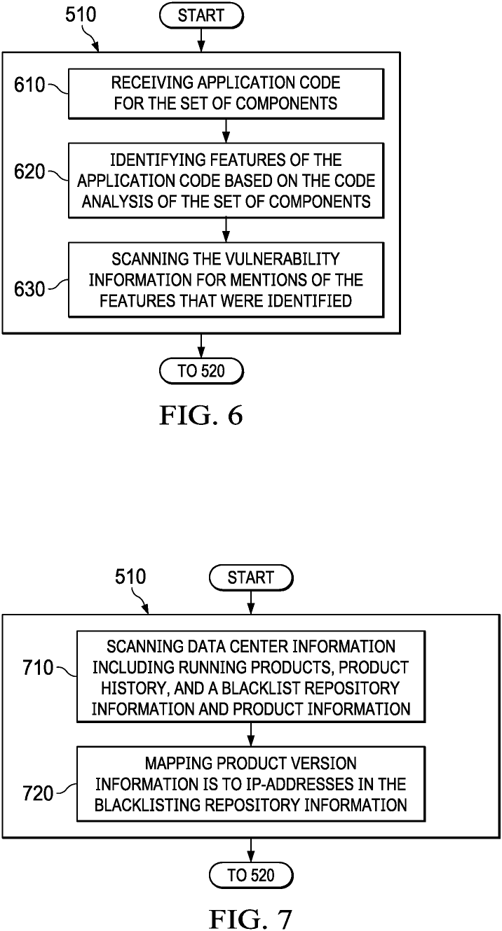

With reference to FIG. 6, a flowchart of a first process for ingesting data about potential vulnerabilities is depicted in accordance with one or more illustrative embodiments. The process illustrated in FIG. 6 is one illustrative example of process step 510 shown in FIG. 5.

The process begins by receiving application code for the set of components (step 610). Features of the application code are identified based on the code analysis of the set of components (step 620). Vulnerability information is scanned for mentions of the features that were identified (step 630). The vulnerability information can include cyber security related articles, cyber security related discussions, and security governance blogs. Thereafter, the process continues to step 520 of FIG. 5.

With reference to FIG. 7, a flowchart of a second process for ingesting data about potential vulnerabilities is depicted in accordance with one or more illustrative embodiments. The process illustrated in FIG. 7 is one illustrative example of process step 510 shown in FIG. 5.

The process scans data center information including running products, product history, and a deny-list repository information and product information (step 710). The process maps Product version information is to IP-addresses in the deny-list repository information. Thereafter, the process may continue to step 520 of FIG. 5

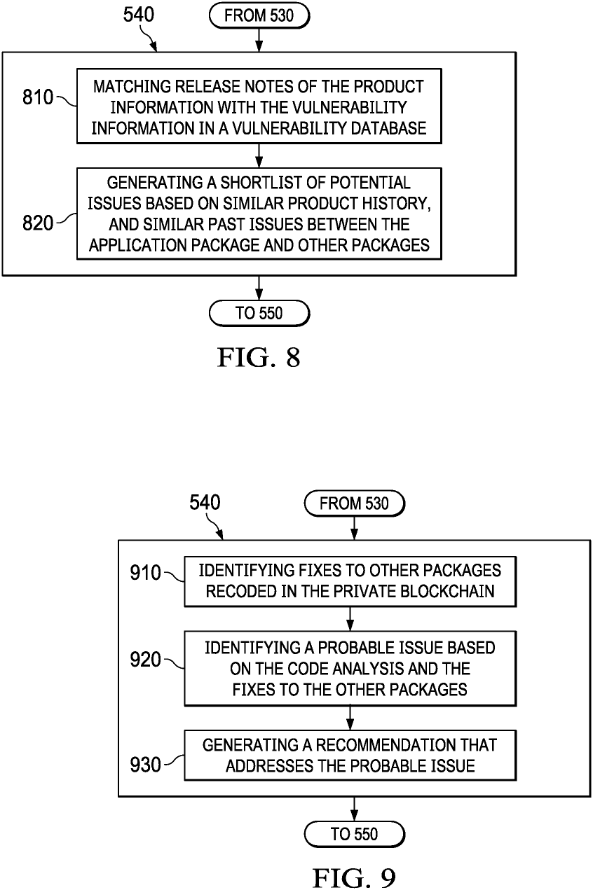

With reference to FIG. 8, a flowchart of a first process for determining a resolution to the vulnerability is depicted in accordance with one or more illustrative embodiments. The process illustrated in FIG. 8 is one illustrative example of process step 540 shown in FIG. 5.

Continuing from step 530 of FIG. 5, the process matches release notes of the product information with the vulnerability information in a vulnerability database (step 810). A short list of potential issues is generated based on similar product history, and similar past issues between the application package and other packages (step 820). Thereafter, the process continues to step 550 of FIG. 5.

With reference to FIG. 9, a flowchart of a second process for determining a resolution to the vulnerability depicted in accordance with one or more illustrative embodiments. The process illustrated in FIG. 9 is one illustrative example of process step 540 shown in FIG. 5.

Continuing from step 530 of FIG. 5, the process identifies mitigations to other packages recoded in the private blockchain (step 910). A probable issue is identified based on the code analysis and the mitigations applied to the other packages (step 920). The process generates a recommendation that addresses the probable issue (step 930). Thereafter, the process continues to step 550 of FIG. 5.

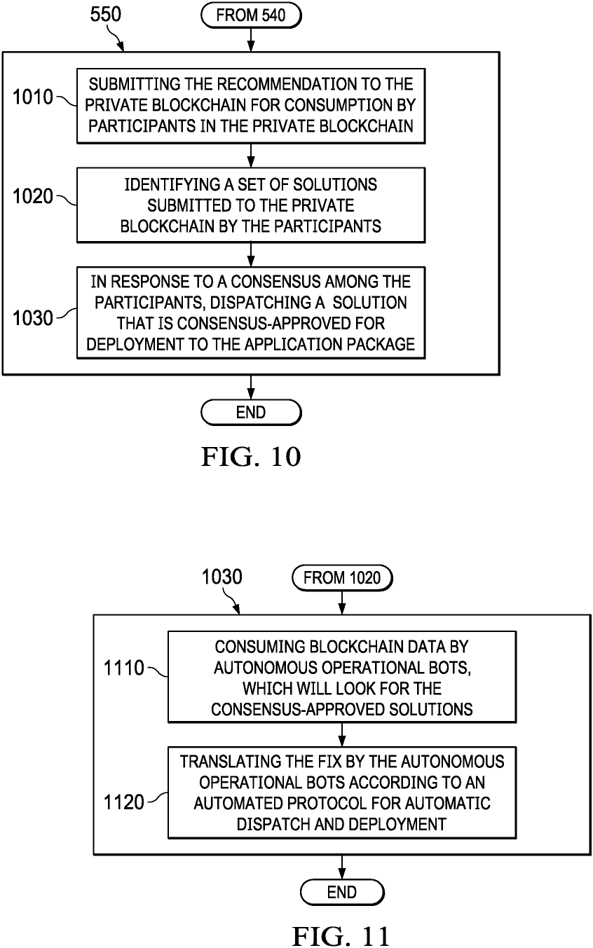

With reference to FIG. 10, a flowchart of a process for managing the recommendation in a private blockchain depicted in accordance with one or more illustrative embodiments. The process illustrated in FIG. 10 is one illustrative example of process step 550 shown in FIG. 5.

Continuing from step 540 of FIG. 5, the process submits the recommendation to a private blockchain for consumption by participants in the private blockchain (step 1010). Sometime thereafter, the process identifies a set of mitigations submitted to the private blockchain by the participants (step 1020). In response to a consensus among the participants, the process dispatches a mitigation that is consensus-approved for deployment to the application package (step 1030). Thereafter, the process terminates.

With reference to FIG. 11, a flowchart of a process for dispatching a mitigation depicted in accordance with one or more illustrative embodiments. The process illustrated in FIG. 11 is one illustrative example of process step 1030 shown in FIG. 5.

Continuing from step 1020 of FIG. 10, the process consumes blockchain data by autonomous operational bots, looking for the consensus-approved mitigations (step 1110). The process translates the mitigation by the autonomous operational bots according to an automated protocol for automatic dispatch and deployment (step 1120). Thereafter, the process terminates.

The flowcharts and block diagrams in the different depicted embodiments illustrate the architecture, functionality, and operation of some possible implementations of apparatuses and methods in one or more illustrative embodiments. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of one or more illustrative embodiments, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In one or more illustrative embodiments, a component can be configured to perform the action or operation described. For example, the component can have a configuration or design for a structure that provides the component an ability to perform the action or operation that is described in the illustrative examples as being performed by the component. Further, to the extent that terms “includes,” “including,” “has,” “contains,” and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for managing zero-day vulnerabilities in an application package having a set of components, the method comprising:
ingesting, by a computer system, data about potential vulnerabilities from a plurality of data sources;
predicting, using a set of machine learning models in the computer system, a vulnerability based on the data that was ingested;
performing, by the computer system, a code analysis of the set of components to identify a possibility of the vulnerability impacting the application package;
generating, by the computer system, a recommendation to resolve the vulnerability based on the code analysis and the data that was ingested; and
managing, by the computer system, the recommendation in a private blockchain.

2. The computer implemented method of claim 1, wherein the data about the potential vulnerabilities comprises crowd-sourced information, vulnerability information, product information, and data center information.

3. The computer implemented method of claim 2, wherein ingesting, by the computer system, data about potential vulnerabilities further comprises:
receiving, by the computer system, application code for the set of components;
identifying, by the computer system, features of the application code based on the code analysis of the set of components; and
scanning, by the computer system, the vulnerability information for mentions of the features that were identified, wherein the vulnerability information includes cyber security related articles, cyber security related discussions, and security governance blogs.

4. The computer implemented method of claim 2, wherein ingesting data, by the computer system, about potential vulnerabilities further comprises:
scanning, by the computer system, data center information including running products, product history, and a deny-list repository information and product information; and
mapping, by the computer system, product version information to internet protocol (IP) addresses in the deny-list repository information.

5. The computer implemented method of claim 2, wherein determining, by the computer system, a resolution to the vulnerability further comprises:
matching, by the computer system, release notes of the product information with the vulnerability information in a vulnerability database; and
generating, by the computer system, a shortlist of potential issues based on similar product history, and similar past issues between the application package and other packages.

6. The computer implemented method of claim 5, wherein determining, by the computer system, the resolution further comprises:
identifying, by the computer system, mitigations to other packages recoded in the private blockchain;
identifying, by the computer system, a probable issue based on the code analysis and the mitigations to the other packages; and
generating, by the computer system, the recommendation that addresses the probable issue.

7. The computer implemented method of claim 1, wherein managing, by the computer system, the recommendation in the private blockchain further comprises:
submitting, by the computer system, the recommendation to the private blockchain for consumption by participants in the private blockchain;
identifying, by the computer system, a set of mitigations submitted to the private blockchain by the participants; and
in response to a consensus among the participants, dispatching, by the computer system, a mitigation that is consensus-approved for deployment to the application package.

8. The computer implemented method of claim 7, wherein dispatching the mitigation further comprises:
consuming blockchain data by autonomous operational bots, looking for the mitigation that has been consensus-approved; and
translating the mitigation by the autonomous operational bots according to an automated protocol for automatic dispatch and deployment.

9. A computer system comprising:
a number of storage devices that store program instructions; and
a number of processor units in communication with the number of storage devices, wherein the number of processor units executes program instructions to:
ingest data about potential vulnerabilities from a plurality of data sources;
predict, using a set of machine learning models, a vulnerability based on the data that was ingested;
perform a code analysis of a set of components to identify a possibility of the vulnerability impacting an application package;
generate a recommendation to resolve the vulnerability based on the code analysis and the data that was ingested; and
manage the recommendation in a private blockchain.

10. The computer system of claim 9, wherein the data about the potential vulnerabilities comprises crowd-sourced information, vulnerability information, product information, and data center information.

11. The computer system of claim 10, wherein in ingesting data about potential vulnerabilities, the number of processor units further executes the program instructions to:
receive application code for the set of components of the application package;
identify features of the application code based on the code analysis of the set of components; and
scan the vulnerability information for mentions of the features that were identified, wherein the vulnerability information includes cyber security related articles, cyber security related discussions, and security governance blogs.

12. The computer system of claim 10, wherein in ingesting data about potential vulnerabilities, the number of processor units further executes the program instructions to:
scan data center information including running products, product history, and a deny-list repository information and product information; and
map product version information to internet protocol (IP) addresses in the deny-list repository information.

13. The computer system of claim 10, wherein in determining a resolution to the vulnerability, the number of processor units further executes the program instructions to:
match release notes of the product information with the vulnerability information in a vulnerability database; and
generate a shortlist of potential issues based on similar product history, and similar past issues between the application package and other packages.

14. The computer system of claim 13, wherein in determining the resolution, the number of processor units further executes the program instructions to:
identify mitigations to other packages recoded in the private blockchain;
identify a probable issue based on the code analysis and the mitigations to the other packages; and
generate the recommendation that addresses the probable issue.

15. The computer system of claim 9, wherein in managing the recommendation in the private blockchain, the number of processor units further executes the program instructions to:
submit the recommendation to the private blockchain for consumption by participants in the private blockchain;
identify a set of mitigations submitted to the private blockchain by the participants; and
in response to a consensus among the participants, dispatch a mitigation that is consensus-approved for deployment to the application package.

16. The computer system of claim 15, wherein in dispatching the mitigation, the number of processor units further executes the program instructions to:
consume blockchain data by autonomous operational bots, looking for the mitigation that has been consensus-approved; and
translate the mitigation by the autonomous operational bots according to an automated protocol for automatic dispatch and deployment.

17. A computer program product for managing zero-day vulnerabilities in an application package having a set of components, the computer program product comprising a computer readable storage medium having program instructions embodied therewith, the program instructions executable by a computer system to cause the computer system to perform a method of:
ingesting data about potential vulnerabilities from a plurality of data sources;
predicting, using a set of machine learning models, a vulnerability based on of the data that was ingested;
performing a code analysis of the set of components to identify a possibility of the vulnerability impacting the application package;
generating a recommendation to resolve the vulnerability based on the code analysis and the data that was ingested; and
managing the recommendation in a private blockchain.

18. The computer program product of claim 17, wherein the data about the potential vulnerabilities comprises crowd-sourced information, vulnerability information, product information, and data center information.

19. The computer program product of claim 17, wherein managing the recommendation in the private blockchain further comprises:
submitting the recommendation to the private blockchain for consumption by participants in the private blockchain;
identifying a set of mitigations submitted to the private blockchain by the participants; and
in response to a consensus among the participants, dispatching a mitigation that is consensus-approved for deployment to the application package.

20. The computer program product of claim 19, wherein dispatching the mitigation further comprises:
consuming blockchain data by autonomous operational bots, looking for the mitigation that has been consensus-approved; and
translating the mitigation by the autonomous operational bots according to an automated protocol for automatic dispatch and deployment.
